(19) United States
(12) Patent Application Publication
(10) Pub. No.: US 2013/0127684 A1
(43) Pub. Date: May 23, 2013

(54) PLASTIC UNIT INTERNALLY EMBEDDED WITH ANTENNA AND MANUFACTURING METHOD OF THE SAME

(71) Applicants: Hsin-Hsien Li, Taoyuan County (TW); Hsin-Ying Wu, Taoyuan County (TW)

(72) Inventors: Hsin-Hsien Li, Taoyuan County (TW); Hsin-Ying Wu, Taoyuan County (TW)

(73) Assignee: Jentech Precision Industrial Co., LTD., Gueishan (TW)

(21) Appl. No.: 13/488,814

(22) Filed: Jun. 5, 2012

(30) Foreign Application Priority Data
Nov. 23, 2011 (TW) 100142938

(51) Int. Cl. H01Q 1/40

(52) U.S. Cl. 343/873

(57) ABSTRACT

The present invention provides a plastic unit internally embedded with an antenna and a manufacturing method of the same. The manufacturing method comprises the steps of preparing a plastic housing, installing an antenna metal wiring on the plastic housing, and covering a heated and softened thermoplastic material on the antenna metal wiring and the plastic housing. The cooled thermoplastic material and the plastic housing are combined as a plastic member. The antenna metal wiring is internally embedded in the plastic member.

### RELATED APPLICATIONS

This application claims priority to Taiwan Application Serial Number 100142938, filed Nov. 23, 2011, which is herein incorporated by reference.

### BACKGROUND

1. Technical Field

The present invention relates to a manufacturing method of a plastic unit, and more particularly to a plastic unit internally embedded with an antenna and a manufacturing method of the same.

2. Description of Related Art

In view of the fact that the design of the housing of an electronic device is something that is taken into consideration when a consumer purchases a product, producers continuously introduce electronic devices with different external designs. A common design technique for the housing of an electronic device involves the use of patterns configured by multiple lines. Through such a design technique, electronic devices that are fashionable and varied in appearance can be made, and such efforts by producers often result in a greater willingness by consumers to purchase these electronic device.

With many modern electronic devices, the outer surface of a plastic unit used as the housing of an electronic device is formed with a metal pattern. That is, a laser processing tool is used to form an antenna metal wiring on the outer surface of the plastic unit, then paint coating and baking are repeated several times (for example, five times) to thereby cover the metal pattern and the outer surface of the plastic unit.

However, even if the metal pattern and the outer surface of the plastic unit have been coated with paint and baked multiple times, the thickness of the paint layers formed on the outer surface of the plastic unit is insufficient, so that the contour of the metal pattern may protrude outwardly and be visible. Moreover, the metal pattern on the plastic unit may be such that an electromagnetic interference (EMI) test cannot be passed.

In addition, since the housing of the electronic device has to be coated with paint and baked multiple times, the manufacturing process is complicated, and involves an excessive use of material and is labor-intensive.

### SUMMARY

The present invention provides a plastic unit internally embedded with an antenna and a manufacturing method of the same. Many advantages are achieved with the present invention. For example, the manufacturing process is simplified to thereby shorten the manufacturing time thereof and minimize material costs and the amount of labor involved. Moreover, the internally embedded antenna is such that it is not overly close to an outer surface of the plastic unit, so that EMI tests can be passed. Additionally, holes formed on a plastic housing can be filled or at least covered, thereby preventing moisture and dust from entering the holes.

In one exemplary embodiment, a manufacturing method of a plastic unit internally embedded with an antenna is provided The manufacturing method comprises preparing a plastic housing, installing an antenna metal wiring on the plastic housing, and covering a heated and softened thermoplastic material on the antenna metal wiring and the plastic housing, thereby enabling the cooled thermoplastic material and the plastic housing to be molten and combined as a plastic member. The antenna metal wiring is internally embedded in the plastic member.

In another exemplary embodiment, a plastic unit internally embedded with an antenna is provided. The plastic unit comprises a plastic member and an antenna metal wiring. The plastic member has an outer surface and an inner surface opposite to the outer surface. The antenna metal wiring is internally embedded in the plastic member, and tightly covered inside the plastic member. The antenna metal wiring has a signal feed-in part protruding and exposed outside the inner surface. Also, a distance is maintained between the antenna metal wiring inside the plastic member and the outer surface, and the distance is sufficient to prevent the antenna metal wiring from protruding from the outer surface of the plastic member.

Yet another exemplary embodiment may provide a plastic unit internally embedded with an antenna. The plastic unit comprises a plastic member and a paint layer. The plastic member comprises a plastic housing, a film and an antenna metal wiring. The plastic housing has a first surface, a second surface, a third surface and a through hole. The first surface is opposite the third surface, the second surface is formed between the first surface and the third surface, and the through hole extends from the first surface to the third surface. The film is tightly covered on the first surface and the second surface of the plastic housing. The antenna metal wiring is disposed between the film and the first surface of the plastic housing, and includes a signal feed-in part protruded along the through hole and exposed outside the third surface. The film has a distance which is sufficient to prevent the antenna metal wiring from protruding from the surface of the film. The paint layer is provided on the outer surface of the plastic member.

With the use of the plastic unit internally embedded with an antenna and the manufacturing method thereof provided by the present invention, paint coating and baking do not need to be performed an excessive number of times, so that the manufacturing process can be simplified, ultimately resulting in a shortening of the manufacturing time, and a reduction in material costs and the amount of labor involved. In addition, a distance is maintained between the antenna metal wiring and the outer surface of the plastic unit, so that the internally embedded antenna is not overly close to the outer surface of the plastic unit, thereby increasing the possibility of passing EMI tests.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flowchart illustrating a manufacturing method of a plastic unit internally embedded with an antenna according to the present invention;

FIG. 2A to FIG. 2C are schematic views illustrating the steps disclosed in FIG. 1;

FIG. 3 is a detail flowchart illustrating one alternative of Step (12) disclosed in FIG. 1;

FIG. 4A and FIG. 4B are schematic views illustrating the steps of FIG. 3;

FIG. 5A is a detail flowchart illustrating one alternative of Step (13) disclosed in FIG. 1;

FIG. 5B is a schematic view showing the appearance of a plastic member after processing according to Step (1313) disclosed in FIG. 5A;

FIG. 6 is a detail flowchart illustrating another alternative of Step (13) disclosed in FIG. 1;

FIG. 7A and FIG. 7B are schematic structural views illustrating the steps disclosed in FIG. 6;

FIG. 8 is a schematic structural view illustrating one alternative of the detail steps after processing according to Step (11) disclosed in FIG. 1;

FIG. 9 is a schematic structural view showing a plastic housing of FIG. 8 after processing according to Step (1213);

FIG. 10A is a schematic structural view after processing according to Step (1313) disclosed in FIG. 7;

FIG. 10B is a schematic structural view after processing according to Step (1322) disclosed in FIG. 7;

FIG. 11A is a schematic structural view after processing according to Step (14) disclosed in FIG. 10A;

FIG. 11B is a schematic structural view after processing according to Step (14) disclosed in FIG. 10B; and

FIG. 12 is a schematic structural view showing a plastic unit in a finished state according to one alternative of the present invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

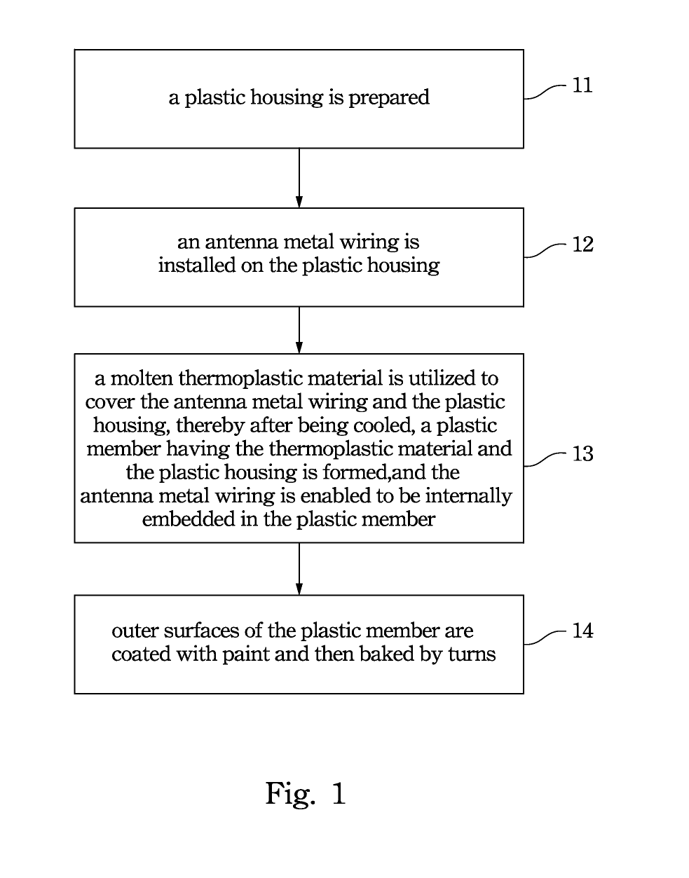

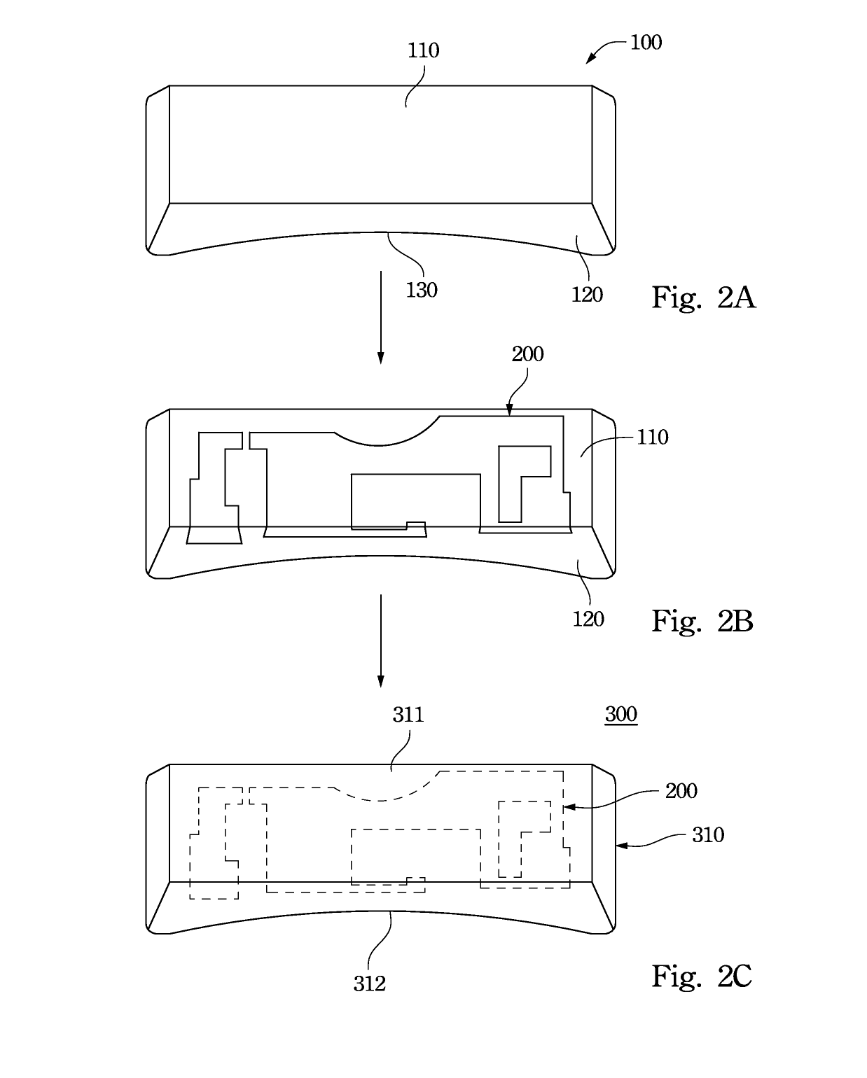

FIG. 1 is a flowchart illustrating a manufacturing method of a plastic unit internally embedded with an antenna according to the present invention, and FIG. 2A to FIG. 2C are schematic views illustrating the steps disclosed in FIG. 1.

The present invention provides a manufacturing method of a plastic unit 300 internally embedded with an antenna. The method comprises the steps as outlined below.

In Step (11), a plastic housing 100 is prepared, as shown in FIG. 2A.

In Step (12), an antenna metal wiring 200 is installed on the plastic housing 100, as shown in FIG. 2B.

In Step (13), a molten thermoplastic material is utilized to cover the antenna metal wiring 200 and the plastic housing 100, thereby after being cooled, a plastic member 310 having the thermoplastic material and the plastic housing 100 is formed, and the antenna metal wiring 200 is enabled to be internally embedded in the plastic member 310, as shown in FIG. 2C.

In Step (14), outer surfaces 311 of the plastic member 310 are coated with paint and then baked by turns.

The manufacture of the plastic housing 100 disclosed in the Step (11) is not limited to any particular process. According to one embodiment of the present invention, the plastic housing 100 can be manufactured by an in-mold injection process, which is referred to herein as a first inner molding process.

Referring to FIG. 2A, the plastic housing 100 is three dimensional, and includes a first surface 110, a second surface 120 and a third surface 130. The first surface 110 and the third surface 130 form two opposite sides of the plastic housing 100. The second surface 120 is located between the first surface 110 and the third surface 130 (i.e., extends between the first and third surfaces 110, 130), and is formed on a plane that is different from planes on which the first surface 110 and the third surface 130 are formed.

Referring to FIG. 2B, in Step (12), the antenna metal wiring 200 is flatly installed on at least two adjacent surfaces (i.e., the first surface 110 and the second surface 120) of the plastic housing 100. That is, the antenna metal wiring 200 is not totally on the same plane, and can be folded along the exterior of the plastic housing 100 so as to be positioned on at least two adjacent surfaces of the plastic housing 100. However, the present invention is not limited to such an arrangement, and the antenna metal wiring 200 can also be provided in a planar state and flatly disposed on a single surface of the plastic housing 100.

In Step (12), the antenna metal wiring 200 can be installed on the plastic housing 100 by either directly forming (or growing) the antenna metal wiring 200 on the plastic housing 100 through sputtering, electroless plating, electro plating or laser processing, or directly disposed an existing antenna product on the plastic housing 100 as shown in FIG. 2B, e.g., disposing an antenna copper foil on the first surface 110 of the plastic housing 100 and extending the antenna copper foil onto the second surface 120 of the plastic housing 100. However, the present invention is not limited in this regard.

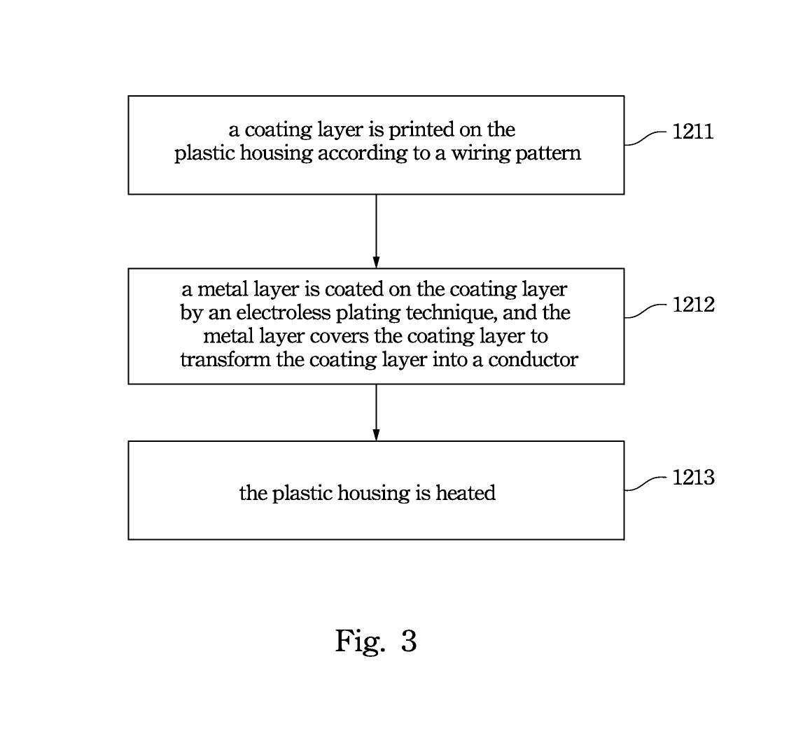

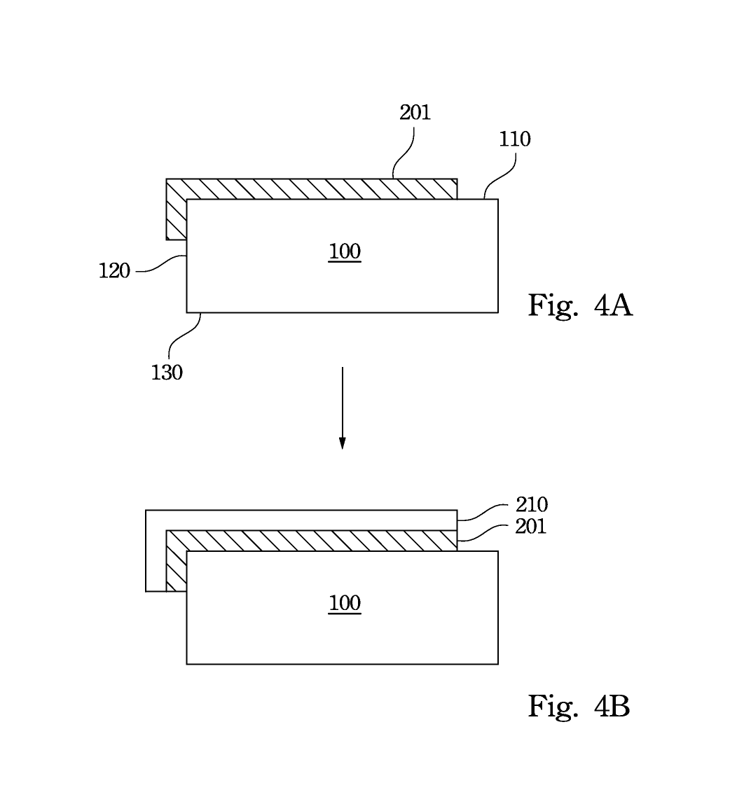

Reference is now made to FIG. 3, FIG. 4A FIG. 4B. FIG. 3 is a detail flowchart illustrating one alternative of Step (12) disclosed in FIG. 1, and FIG. 4A and FIG. 4B are schematic views illustrating the steps of FIG. 3.

With respect to directly forming the antenna metal wiring 200 on the plastic housing 100, this may be performed through an electroless plating method which includes the steps as outlined below.

In Step (1211), a coating layer 201 (i.e., a printing media layer) is printed on the plastic housing 100 according to a wiring pattern, as shown in FIG. 4A.

In this step, a screen-printing technique, for example, can be utilized to coat the coating layer 201 on the first surface 110 and the second surface 120 of the plastic housing 100 on areas thereof that corresponds to the pattern of the antenna metal wiring 200. The coating layer 201 is an insulation layer according to one embodiment of the present invention.

In this embodiment, for forming the wiring pattern on two adjacent surfaces of the plastic housing 100, a three-dimensional printing technology can be utilized to sequentially print the coating layer 201 on the first surface 110 and the adjacent second surface 120 of the plastic housing 100, so as to form a wiring pattern that extends to different planes.

According another embodiment of the present invention, for forming a planar antenna metal wiring, the coating layer 201 only needs to be printed on a single surface of the plastic housing 100 to thereby result in the formation of a single-plane wiring pattern.

In Step (1212), a metal layer 210 is coated on the coating layer 201 by an electroless plating technique. The metal layer 210 covers the coating layer 201 so as to transform the coating layer 201 into a conductor, and the coating layer 201 (i.e., the printing media layer) is made thicker so that the antenna metal wiring 200 is formed, as shown in FIG. 4A and FIG. 4B.

If an electroless plating technique, for example, an electroless copper plating technique, is used, regardless of whether the coating layer 201 is printed on a single plane or different planes, the metal layer 210 is simply sputtered on the coating layer 201, so that the metal layer 210 has the same shape as the wiring pattern.

In Step (1213), the plastic housing 100 is heated. For example, the plastic housing 100 is disposed in a heating device for 3 to 5 minutes that is set to at least 130 degrees Celsius, so that the metal layer 210 can be stably disposed on the coating layer 201.

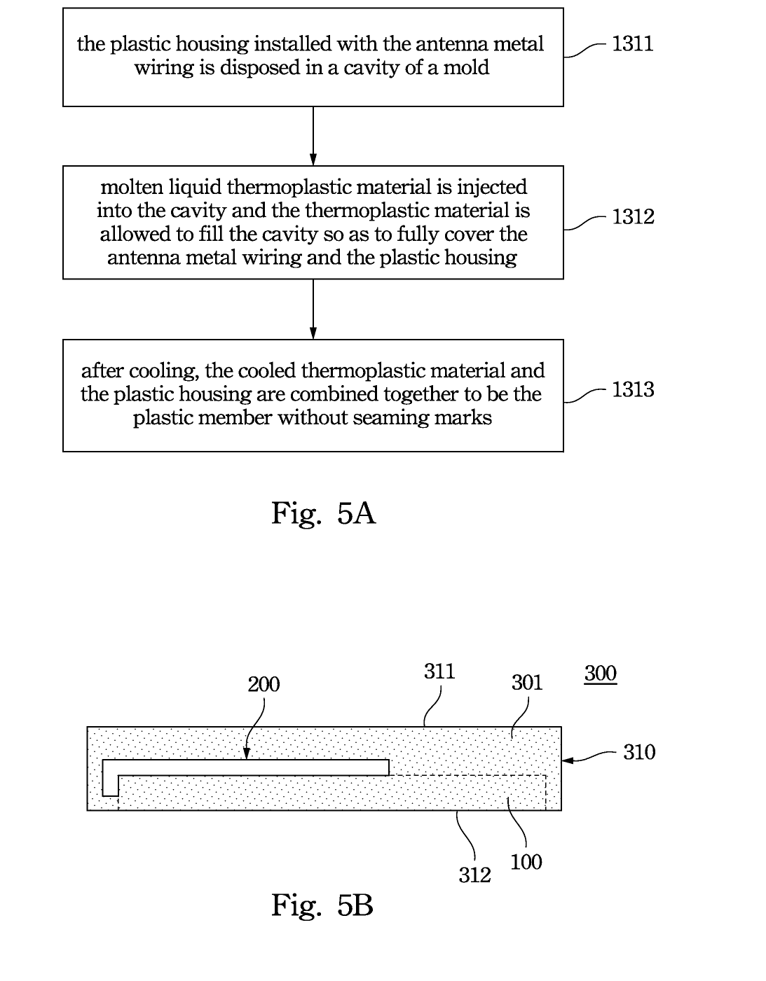

Reference is now made to FIG. 5A and FIG. 5B. FIG. 5A is a detail flowchart illustrating one alternative of Step (13) disclosed in FIG. 1, and FIG. 5B is a schematic view showing the appearance of the plastic member after processing according to Step (1313) disclosed in FIG. 5A.

According to one another embodiment of the present invention, Step (13) of utilizing the thermoplastic material to cover the antenna metal wiring 200 and the plastic housing 100 can be performed by either of two alternatives described below. These two alternatives will be indicated using (I) and (II). (I) Another in-mold injection technique (referred to as a second inner molding) is used to allow the thermoplastic material to envelop the plastic housing 100 to be integrally and seamlessly combined as the plastic member 310.

The detail steps are as outlined below.

In Step (1311), the plastic housing 100 installed with the antenna metal wiring 200 is disposed in a cavity of a mold.

In Step (1312), the cavity is injected with molten liquid thermoplastic material, and the thermoplastic material is allowed to fill the cavity so as to fully cover the antenna metal wiring 200 and the plastic housing 100, i.e., the liquid thermoplastic material covers the first surface 110 of the plastic housing 100 and the antenna metal wiring 200 installed on the first surface 110 of the plastic housing 100.

In Step (1313), after cooling, the cooled thermoplastic material 301 and the plastic housing 100 are combined together to be the plastic member 310 without seaming marks, as shown in FIG. 5B.

It is noted that the present invention is not limited with respect to whether the thermoplastic material and the material of the plastic housing 100 are the same, and the thermoplastic material can be a light-pervious or transparent plastic material.

If an antenna product (such as an antenna copper foil) is bent to be located on different planes, when Step (1311) is performed, a thimble in the cavity can be operated to push against the bent portion of the antenna product, so that the antenna product internally embedded in the plastic member can have the desired shape.

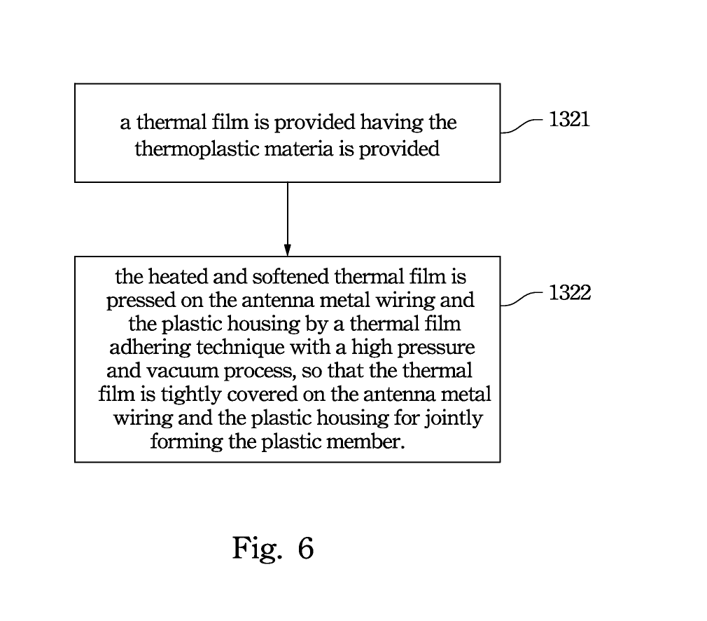

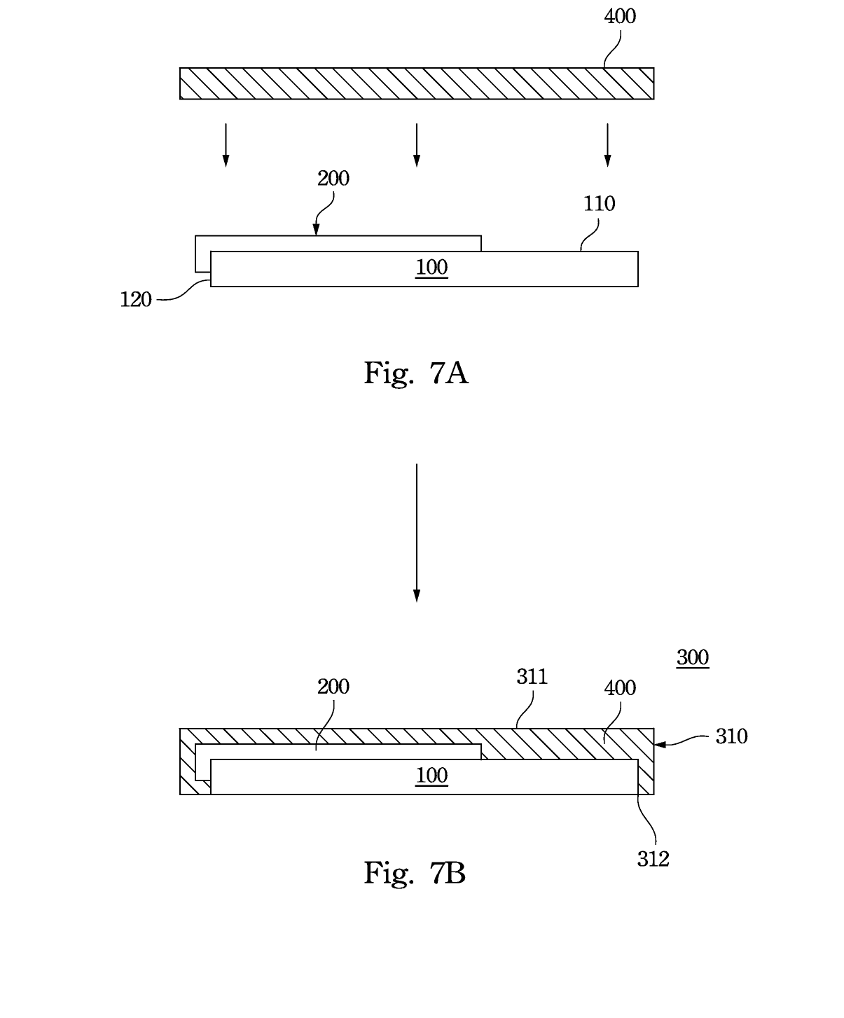

(II) An outside mold decoration technique is used to cover a film 400 having the thermoplastic material on the first surface 110 of the plastic housing 100. Reference is now made to FIG. 6, FIG. 7A and FIG. 7B. FIG. 6 is a detail flowchart illustrating another alternative of Step (13) disclosed in FIG. 1, and FIG. 7A and FIG. 7B are schematic structural views illustrating the steps disclosed in FIG. 6.

The detail steps are as outlined below.

In Step (1321), a thermal film 400 having the thermoplastic material therein is provided.

In Step (1322), the heated and softened thermal film 400 is pressed on the antenna metal wiring 200 and the plastic housing 100 by a thermal film adhering technique with a high pressure and vacuum process, so that the thermal film 400 can be tightly covered on the antenna metal wiring 200 and the first surface 110 and the second surface 120 of the plastic housing 100 for jointly forming these elements as the plastic member 310.

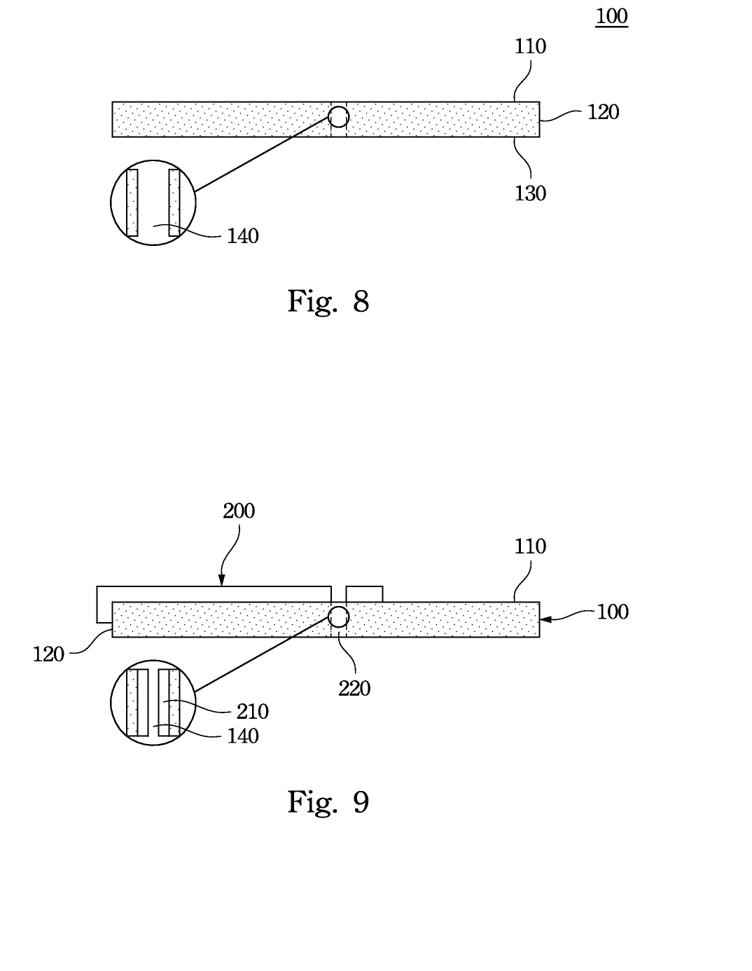

Reference is now made to FIG. 8 which is a schematic structural view illustrating one alternative of the detail steps after processing according to Step (11) disclosed in FIG. 1.

According to one alternative of the detail steps provided by the present invention, a step of forming a through hole 140 in the plastic housing 100 can be further included between Step (11) and Step (12). The through hole 140 extends from the first surface 110 to the third surface 130 of the plastic housing 100.

Reference is now made to FIG. 9 which is a schematic structural view showing the plastic housing 100 of FIG. 8 after processing according to Step (1213).

When the wiring pattern passes through the through hole 140, the coating layer 201 is printed on the inner wall of the through hole 140, i.e., the coating layer 201 extends from the first surface 110 of the plastic housing 100 towards the third surface 130 of the plastic housing 100 along the inner wall of the through hole 140.

According to Step (1212) and Step (1213), the electroless-plated metal layer 210 is extended from the first surface 110 of the plastic housing 100 towards the third surface 130 of the plastic housing 100 along the inner wall of the through hole 140, then is exposed outside the third surface 130 of the plastic housing 100. However, the present invention is not limited to such an arrangement, and a guide wire can be alternatively used for conducting the first surface 110 of the plastic housing 100 along the through hole 140.

In addition, regardless of whether the antenna metal wiring 200 is directly formed on the plastic housing 100 or separately made and then disposed on the plastic housing 100, the antenna metal wiring 200 can utilize the through hole 140 to extend from the first surface 110 of the plastic housing 100 to the third surface 130 of the plastic housing 100 and to be exposed outside the third surface 130 of the plastic housing 100, thereby forming a signal feed-in part 220, as shown in FIG. 9.

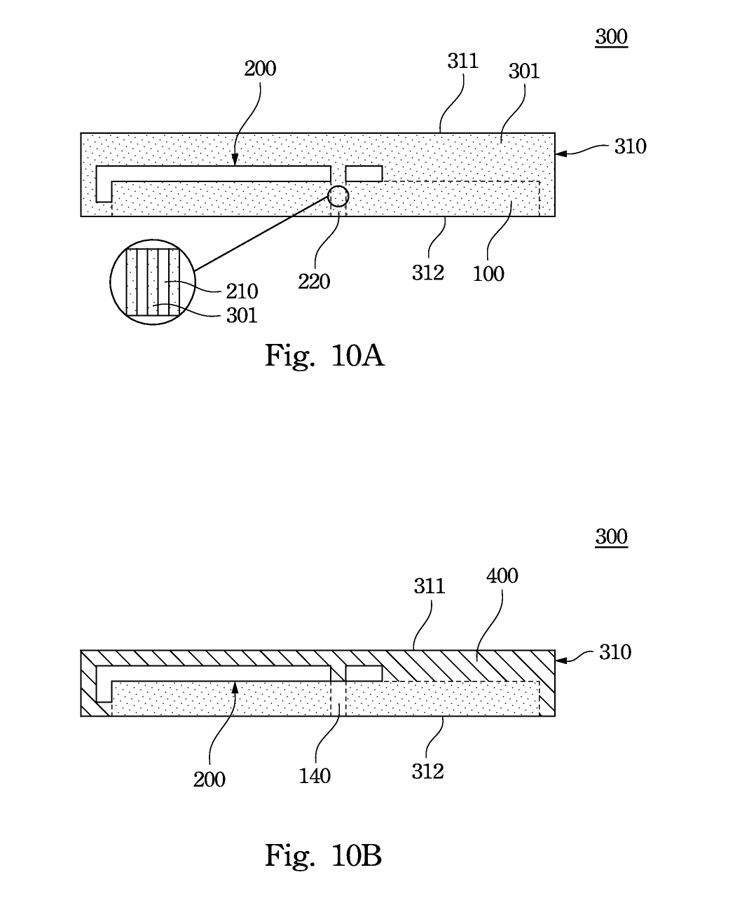

Reference is now made to FIG. 10A which is a schematic structural view after being processing according to Step (1313) disclosed in FIG. 7.

When the through hole 140 is formed and processed according to Step (1313), the heated liquid thermoplastic material flows into the through hole 140 and fills the same. When the through hole 140 is filled, external moisture or dusts can be prevented from entering the through hole 140.

Reference is now made to FIG. 10B which is a schematic structural view after processing according to Step (1322) disclosed in FIG. 7.

When the through hole 140 is formed and processed according to Step (1322), the heated and softened film 400 not only covers the antenna metal wiring 200 and the first surface 110 and the second surface 120 of the plastic housing 100, but also covers the through hole 140. When the through hole 140 is covered, external moisture and dusts can be prevented from entering the through hole 140.

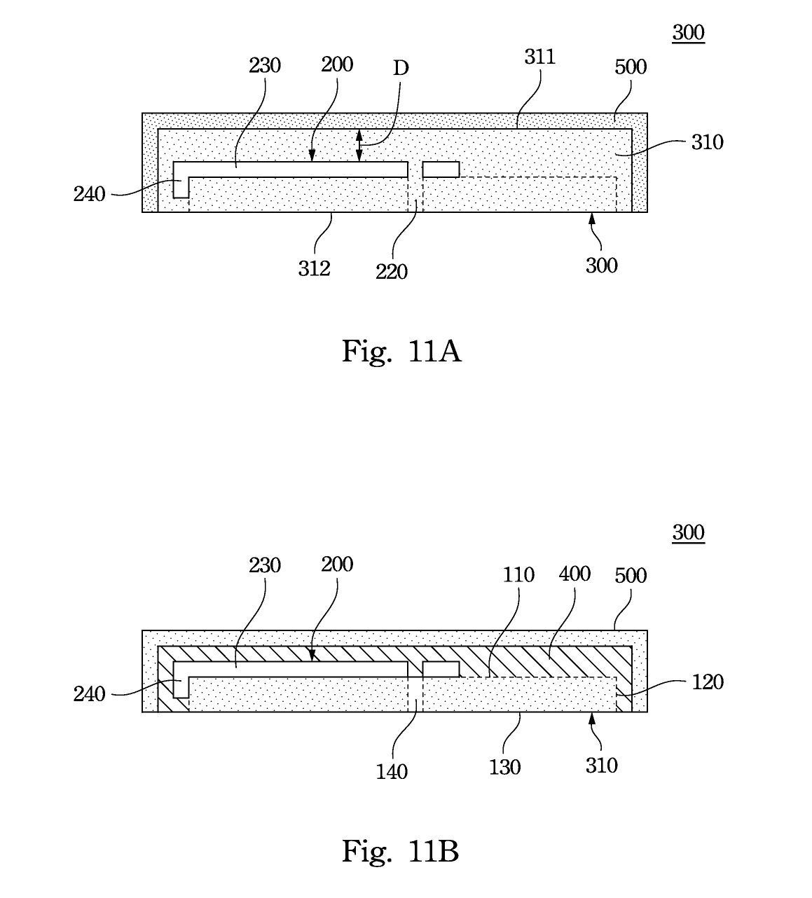

Reference is now made to FIG. 11A which is a schematic structural view after processing according to Step (14) disclosed in FIG. 10A.

After the plastic member 310 shown in FIG. 10A undergoes repeated processing (two times at most) of paint coating and baking, the surface thereof is able to be processed with a surface smoothing treatment and an appearance treatment. Through such processing, the outer surface 311 of the plastic unit 300 is coated with a paint layer 500. The paint layer 500 can be a single layer or multiple layers.

Reference is now made to FIG. 11 B which is a schematic structural view after processing according to Step (14) disclosed in FIG. 10B.

After the plastic member 310 shown in FIG. 10B undergoes repeated processing (two times at most) of paint coating and baking, the surface thereof is able to be processed with a surface smoothing treatment and an appearance treatment. Through such processing, the outer surface of the film 400 is coated with a paint layer 500 for providing an initial plastic product. The paint layer 500 can be a single layer or multiple layers.

It is noted the step of paint coating and baking is well known by persons skilled in the art, and so a detailed description in this regard will not be provided.

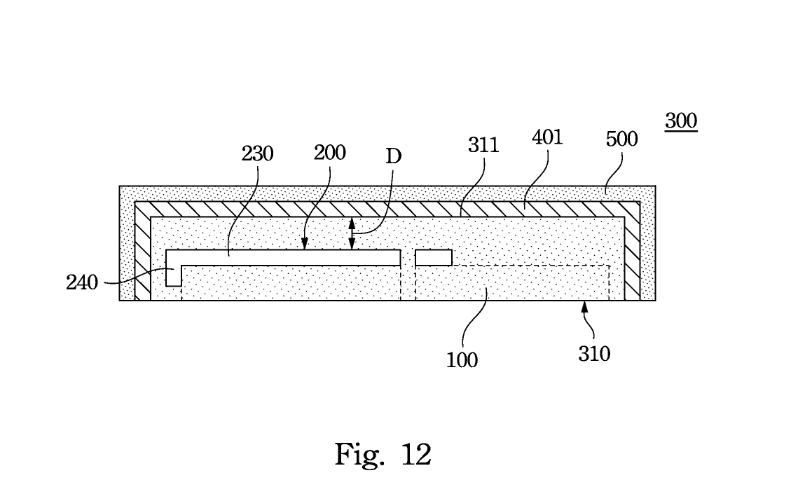

Reference is now made to FIG. 12 which is a schematic structural view showing the plastic unit 300 in a finished state according to one alternative of the present invention.

According to one alternative of the present invention, when the antenna metal wiring 200 and the plastic housing 100 are processed with the second inner molding for forming the plastic member 310, a step of outside mold decoration can be further included between Step (13) and Step (14) shown in FIG. 1 to thereby allow a film 401 containing the thermoplastic material to be covered on the outer surface 311 of the plastic member 310 and other outer surfaces 311 adjacent to said outer surface 311, thereby enhancing the waterproof capability of the plastic member 310, after which Step (14) is performed.

Referring to FIG. 2C and FIG. 11A, another alternative of the present invention is to provide a plastic unit 300 internally embedded with an antenna which is formed through the manufacturing method described above. The plastic unit 300 includes a plastic member 310 and an antenna metal wiring 200. In one embodiment of the present invention, the plastic member 310 can be a housing of an electronic device or an internal component inside the housing of an electronic device. The plastic member 310 has an outer surface 311 and an inner surface 312 opposite to the outer surface 311. The antenna metal wiring 200 is internally embedded in the plastic member 310, and includes a first part 230 and a second part 240 which are arranged on different planes. The first part 230 is extended according to the extending direction of the outer surface 311. The second part 240 and the first part 230 define an angle therebetween, and the second part 240 is extended towards the inner surface 312 from the first part 230. Moreover, the antenna metal wiring 200 includes a signal feed-in part 220 protruding and being exposed outside the inner surface 312.

The antenna metal wring 200 is spaced from the outer surface 311 by a distance D, and the distance D is sufficient to prevent the antenna metal wiring 200 from protruding from the outer surface 311 of the plastic member 310. That is, the antenna metal wiring 200 is not overly close to the outer surface 311 of the plastic member 310, so that EMI tests can be easily passed. Moreover, the plastic unit 300 further includes a paint layer 500 and/or a film 401 formed on the outer surface of the plastic member 310.

Referring to FIG. 2C and FIG. 11 B, another alternative of the present invention provides a plastic unit internally embedded with an antenna.

The plastic unit includes a plastic member 310 and a paint layer 500. The paint layer 500 is covered on the outer surface of the plastic member 310. The plastic member 310 includes a plastic housing 100, a film 400 and an antenna metal wiring 200. The plastic housing 100 includes a first surface 110, a second surface 120, a third surface 130 and a through hole 140. The first surface 110 is opposite the third surface 130, and the second surface 120 is formed between the first surface 110 and the third surface 130. The through hole 140 extends from the first surface 110 to the third surface 130. The film 400 is tightly covered on the first surface 110 and the second surface 120 of the plastic housing 100. The antenna metal wiring 200 is disposed between the film 400 and the first surface 110 of the plastic housing 100, and includes a first part 230 and a second part 240 which are formed on different planes. The first part 230 is extended towards the direction of the first surface 110. The second part 240 and the first part 230 define an angle and the second part 240 is extended towards the direction of the third surface 130. Moreover, the antenna metal wiring 200 includes a signal feed-in part 220 protruded along the through hole 140 and exposed outside the third surface 130. The antenna metal wring 200 is spaced from the film 400 by a distance D, and the distance D is sufficient to prevent the antenna metal wiring 200 from protruding from the surface of the film 400.

With the plastic unit internally embedded with an antenna and the manufacturing method thereof provided by the present invention, the number of times that the step of paint coating and baking needs to be performed can be decreased to a reasonable level. Hence, the manufacturing process can be simplified to thereby shorten the manufacturing time and minimize material costs and the amount of labor involved. In addition, a distance is maintained between the antenna metal wiring and the outer surface of the plastic unit, so the internally embedded antenna is not overly close to the outer surface of the plastic unit, thereby ensuring that EMI tests can be passed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A manufacturing method of a plastic unit internally embedded with an antenna, comprising:
preparing a plastic housing;
installing an antenna metal wiring on the plastic housing; and
covering a heated and softened thermoplastic material on the antenna metal wiring and the plastic housing, thereby enabling the cooled thermoplastic material and the plastic housing to be combined as a plastic member, wherein the antenna metal wiring is internally embedded in the plastic member.

2. The manufacturing method of a plastic unit internally embedded with an antenna according to claim 1, wherein the step of installing the antenna metal wiring on the plastic housing comprises:
forming a coating layer on a surface of the plastic housing; and
is utilizing an electroless plating technique to form a metal layer on the coating layer so that the metal layer covers the coating layer, thereby directly forming the antenna metal wiring on the plastic housing.

3. The manufacturing method of a plastic unit internally embedded with an antenna according to claim 1, wherein the step of installing the antenna metal wiring on the plastic housing comprises:
disposing an existing antenna product on a surface of the plastic housing.

4. The manufacturing method of a plastic unit internally embedded with an antenna according to claim 1, wherein the step of installing the antenna metal wiring on the plastic housing comprises:
installing the antenna metal wiring on two adjacent surfaces of the plastic housing.

5. The manufacturing method of a plastic unit internally embedded with an antenna according to claim 1 further comprising:
forming a through hole in the plastic housing for penetrating two opposite surfaces of the plastic housing before the step of installing the antenna metal wiring on the plastic housing;
wherein the step of installing the antenna metal wiring on the plastic housing further comprises:
is providing the antenna metal wiring from one of the opposite surfaces of the plastic housing along the through hole for being exposed on the other opposite surface of the plastic housing; and
wherein the step of covering the heated and softened thermoplastic material on the antenna metal wiring and the plastic housing further comprises:
sealing the through hole by the heated and softened thermoplastic material.

6. The manufacturing method of a plastic unit internally embedded with an antenna according to claim 1, wherein the step of covering the heated and softened thermoplastic material on the antenna metal wiring and the plastic housing, further comprises:
disposing the plastic housing in a cavity of a mold; and
utilizing an in-mold injection technique to allow the heated and liquid thermoplastic material to be filled in the cavity for fully covering the antenna metal wiring and the plastic housing, wherein the cooled thermoplastic material and the plastic housing are seamlessly combined as a plastic member without the generation of slits.

7. The manufacturing method of a plastic unit internally embedded with an antenna according to claim 1, wherein the step of covering the heated and softened thermoplastic material on the antenna metal wiring and the plastic housing, further comprises:
providing a film having the thermoplastic material; and
utilizing a thermal film adhering technique to allow the heated and softened film to be tightly covered on the antenna metal wiring and the plastic housing for jointly forming as the plastic member.

8. A plastic unit internally embedded with an antenna, comprising:
a plastic member having an outer surface and an inner surface opposite to the outer surface; and
an antenna metal wiring internally embedded in the plastic member, and tightly covered inside the plastic member, the antenna metal wiring having a signal feed-in part protruding and being exposed outside the inner surface,
wherein a distance is maintained between the antenna metal wiring inside the plastic member and the outer surface, and the distance is sufficient to prevent the antenna metal wiring from protruding from the outer surface of the plastic member.

9. The plastic unit according to claim 8, wherein the antenna metal wiring includes a first part and a second part which are arranged on different planes.

10. A plastic unit internally embedded with an antenna, comprising:
a plastic member comprising:
a plastic housing having a first surface, a second surface, a third surface and a through hole, wherein the first surface is opposite the third surface, the second surface is formed between the first surface and the third surface, and the through hole extends from the first surface to the third surface;
a film tightly covered on the first surface and the second surface of the plastic housing; and
an antenna metal wiring disposed between the film and the first surface of the plastic housing, and including a signal feed-in part protruded along the through hole and exposed outside the third surface, wherein the film has a distance which is sufficient to prevent the antenna metal wiring from protruding from the surface of the film; and
a paint layer provided on the outer surface of the plastic member.

11. The plastic unit according to claim 10, wherein the antenna metal wiring includes a first part and a second part which are arranged on different planes.
